(19) United States
(12) Patent Application Publication
(10) Pub. No.: US 2016/0308288 A1
(43) Pub. Date: Oct. 20, 2016

(54) FASTENING MECHANISM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: WEN-HSIANG HUNG, New Taipei (TW); CHUN-BAO GU, Wuhan (CN); HONG-MEI ZHANG, Wuhan (CN)

(21) Appl. No.: 14/715,028

(22) Filed: May 18, 2015

(30) Foreign Application Priority Data
Apr. 16, 2015 (CN) 201510180000.9

(51) Int. Cl. H01R 4/50; H01R 13/58

(52) U.S. Cl. CPC H01R 4/5066; H01R 13/5816

(57) ABSTRACT

A fastening mechanism is used to fix a plurality of data cables on an electronic component. The electronic component includes a circuit board. The fastening mechanism includes a latch portion and a sliding portion connected with the latch portion. The latch portion defines a latch groove. The sliding portion defines a plurality of sliding grooves. The data cables are received in the sliding grooves and are connected with the circuit board. The latch groove is configured to receive the circuit board to fix the data cables on the electronic component.

### CROSS-REFERENCE TO RELATED APPLICATIONS

This application claims priority to Chinese Patent Application No. 201510180000.9 filed on Apr. 16, 2015, the contents of which are incorporated by reference herein.

### FIELD

The subject matter herein generally relates to a fastening mechanism.

### BACKGROUND

Some electronic components need to be connected with a plurality of data cables. However, the data cables can be easily loosened from the electronic component.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a fastening mechanism, an electronic component and two data cables.

FIG. 2 is an isometric view of the fastening mechanism.

FIG. 3 is an isometric, assembled view of the fastening mechanism, the electronic component and the data cables of FIG. 1.

FIG. 4 is similar to FIG. 3, but viewed from a different angle.

FIG. 5 is a cross sectional view of the fastening mechanism and the data cables of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

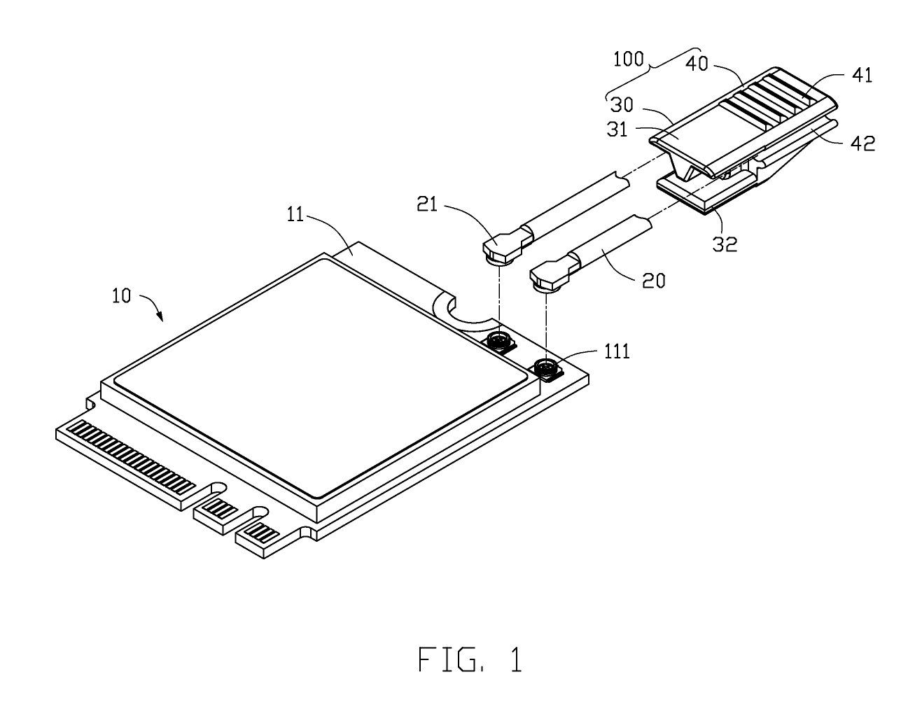

FIG. 1 illustrates one embodiment of a fastening mechanism 100. The fastening mechanism 100 is used to fix a plurality of data cables 20 on an electronic component 10. In one embodiment, two data cables 20 are shown in FIG. 1.

The electronic component 10 includes a circuit board 11. One end of the circuit board 11 defines two interfaces 111. One end of each data cable 20 is equipped with a connector 21. The connectors 21 can be inserted into the interfaces 111 to connect the data cables 20 to the electronic component 10.

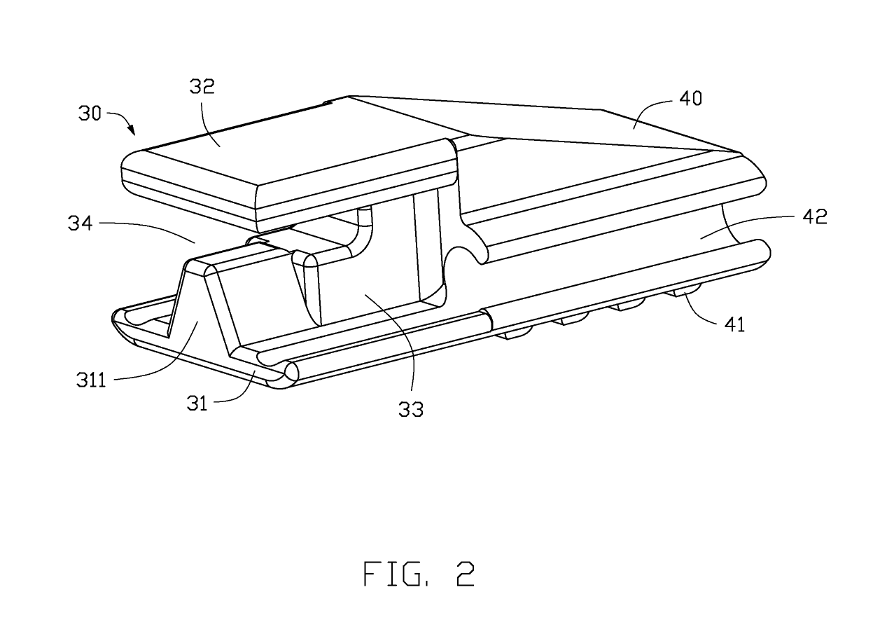

FIGS. 1 and 2 illustrate the fastening mechanism 100 includes a latch portion 30 and a sliding portion 40 connected with the latch portion 30. The latch portion 30 includes a top plate 31 and a bottom plate 32. A connection piece is connected between central portions of the top plate 31 and the bottom plate 32 to deform two receiving spaces 33 between the top plate 31 and the bottom plate 32. A protrusion 311 is protruded from the top plate 31 towards the bottom plate 32. A latch groove 34 is defined between the protrusion 311 and the bottom plate 32. The two receiving spaces 33 communicate with each other via the latch groove 34. A width of the latch groove 34 is substantially equal to a thickness of the circuit board 11. A top edge of the sliding portion 40 is equipped with a plurality of protrusive strips 41 which are used to conveniently push the fastening mechanism 100. Each side of the sliding portion 40 defines a sliding groove 42. The sliding groove 42 communicates with the receiving space 33.

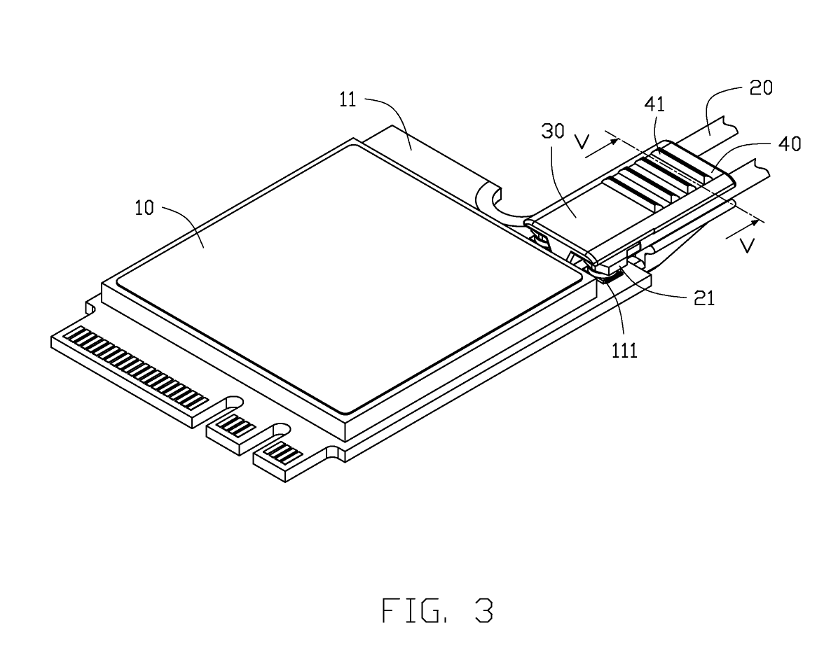

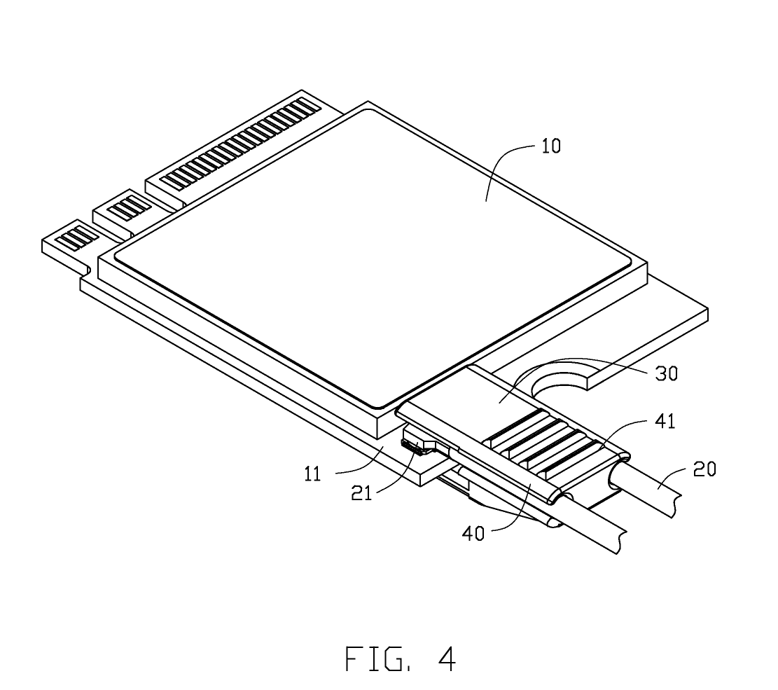

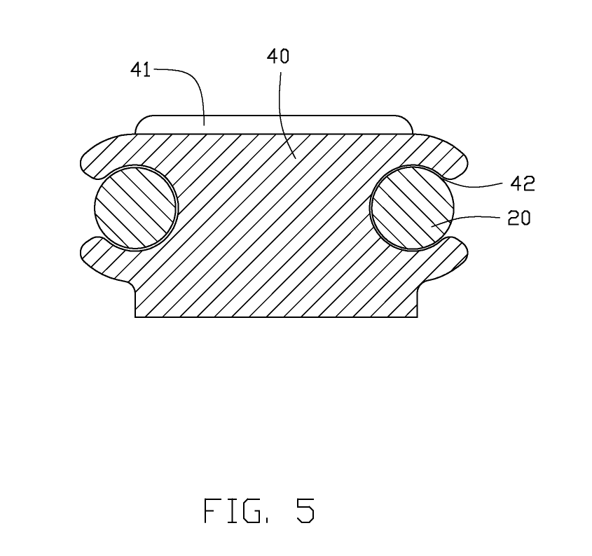

FIGS. 3 to 5 illustrate when in assembly, the two data cables 20 are slidably installed in the sliding groove 42. The two connectors 21 are fixed on one end of the two data cables 20. The data cables 20 are located on the circuit board 11. The connectors 21 are inserted into the interfaces 111 of the circuit board 11 to connect the data cables 20 with the electronic component 10. The fastening mechanism 100 is pushed towards to the electronic component 10. The circuit board 11 is inserted into the latch groove 34. The protrusion 311 and the bottom plate 32 are respectively latched on the two sides of the circuit board 11. The connectors 21 are received in the receiving space 33. Then, the fastening mechanism 100 fastens the data cables 20 on the electronic component 10 to prevent the data cables 20 from becoming loose.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A fastening mechanism for attaching a plurality of data cables to an electronic component comprising a circuit board, comprising:
a latch portion, the latch portion defining a latch groove; and
a sliding portion connected with the latch portion and defining a plurality of sliding grooves configured to receive a plurality of data cables;
wherein the latch groove is configured to receive the circuit board and to fix the data cables to the electronic component.

2. The fastening mechanism of claim 1, wherein one end of the circuit board defines a plurality of interfaces, the data cables are configured to fix on the interfaces to be connected with the electronic component.

3. The fastening mechanism of claim 2, wherein one end of the data cable is equipped with a connector, the connector can be inserted into the interface to connect the data cable with the electronic component.

4. The fastening mechanism of claim 3, wherein the latch portion comprises a top plate and a bottom plate parallel to the top plate, two receiving spaces are located between the top plate and the bottom plate, the connector can be received in the receiving space.

5. The fastening mechanism of claim 4, wherein the top plate is equipped with a protrusion along the direction of the bottom plate, the latch groove is located between the protrusion and the bottom plate.

6. The fastening mechanism of claim 5, wherein the latch groove is defined between the two receiving spaces, and is communicated with the two receiving spaces.

7. The fastening mechanism of claim 6, wherein a width of the latch groove is substantially equal to a thickness of the circuit board.

8. The fastening mechanism of claim 4, wherein the sliding groove is communicated with the receiving space.

9. The fastening mechanism of claim 1, wherein a top edge of the sliding portion is equipped with a plurality of protrusive strips which are used to conveniently push the fastening mechanism.

10. An electronic device, comprising:
an electronic component comprising a circuit board;
a plurality of data cables;
a latch portion, the latch portion defining a latch groove; and
a sliding portion connected with the latch portion, the sliding portion defining a plurality of sliding grooves;
wherein the data cables are received in the sliding grooves and are connected with the circuit board, the latch groove is configured to receive the circuit board and to fix the data cables to the electronic component.

11. The electronic device of claim 10, wherein one end of the circuit board defines a plurality of interfaces, the data cables are configured to fix on the interfaces to be connected with the electronic component.

12. The electronic device of claim 11, wherein one end of the data cable is equipped with a connector, the connector can be inserted into the interface to connect the data cable with the electronic component.

13. The electronic device of claim 12, wherein the latch portion comprises a top plate and a bottom plate parallel to the top plate, two receiving spaces are located between the top plate and the bottom plate, the connector can be received in the receiving space.

14. The electronic device of claim 13, wherein the top plate is equipped with a protrusion along the direction of the bottom plate, the latch groove is located between the protrusion and the bottom plate.

15. The electronic device of claim 14, wherein the latch groove is defined between the two receiving spaces, and is communicated with the two receiving spaces.

16. The electronic device of claim 15, wherein a width of the latch groove is substantially equal to a thickness of the circuit board.

17. The electronic device of claim 13, wherein the sliding groove is communicated with the receiving space.

18. The electronic device of claim 10, wherein a top edge of the sliding portion is equipped with a plurality of protrusive strips which are used to conveniently push the fastening mechanism.
